(19) United States
(12) Patent Application Publication
(10) Pub. No.: US 2016/0165571 A1
(43) Pub. Date: Jun. 9, 2016

(54) System and Method for Sending and Receiving Messages by a User Having Multiple Personas Associated with Respective Telephone Numbers

(71) Applicants: AT&T Intellectual Property I, L.P., Atlanta, GA (US); AT&T Mobility II LLC, Atlanta, GA (US)

(72) Inventors: Daniel P. Malee, Wheaton, IL (US); Diane Didio, Toms River, NJ (US); Cindy Goodman, Cypress, TX (US); Mingwun Li, Dallas, TX (US); Gregory Miller, Boca Raton, FL (US); Noel Travers, Washington, NJ (US)

(73) Assignees: AT&T MOBILITY II LLC, Atlanta, GA (US); AT&T INTELLECTUAL PROPERTY I, L.P., Atlanta, GA (US)

(21) Appl. No.: 14/564,861

(22) Filed: Dec. 9, 2014

(51) Int. Cl. H04W 68/02; H04W 4/12

(52) U.S. Cl. CPC H04W 68/02; H04W 4/12

(57) ABSTRACT

A first message addressed to a telephone number associated with a user is received. It is determined that the telephone number is associated with a persona based messaging service. In response to determining that the telephone number is associated with a persona based messaging service, the first message is stored in a mailbox associated with the user. A notification is transmitted to a messaging server that the first message is stored in the mailbox. The first message is retrieved. A push notification is transmitted to a client associated with the telephone number via a wireless network.

### FIELD

The present disclosure relates generally to a system and method for sending and receiving messages by a user having multiple personas associated with respective telephone numbers and more particularly to a system and method for sending and receiving Short Message Service (SMS) and Multimedia Messaging Service (MMS) messages by a user having multiple personas associated with respective telephone numbers.

### BACKGROUND

An employee that works for a company that requires him/her to answer business-related telephone calls, electronic mail (email) messages, text or multimedia messages, etc. typically has to carry either a separate device that is dedicated to his/her business needs or use his/her personal device for mixed personal and business use. If the employee opts to use his/her personal device for mixed personal and business use, this is referred to as bring your own device (BYOD). BYOD users face challenges associated with mixing business and personal use on a single device. For example, company security policies may restrict access to sensitive company data from personal devices. Or, the company's Information Technology (IT) administrator may request access to the device in order to install a corporate email client for purposes of transmitting and receiving business email. The company may request to access the user's device which is used for mixed personal and business use at any time, especially when the employee is terminated or leaving the company. Also, using a personal device for business use can lead to potential mix-ups between business and personal contacts. For example, an incoming message that is business related may be mistakenly responded to as if it was a personal message. Pocket dialing, a child using the device to send a message out by mistake, etc. are also potential problems faced by BYOD users.

### BRIEF SUMMARY

The present application provides a method, system and computer readable medium for sending and receiving messages by a user having multiple personas associated with respective telephone numbers. A first message addressed to a telephone number associated with a user is received. It is determined that the telephone number is associated with a persona based messaging service. In response to determining that the telephone number is associated with a persona based messaging service, the first message is stored in a mailbox associated with the user. A notification is transmitted to a messaging server that the first message is stored in the mailbox. The first message is retrieved. A push notification is transmitted to a client associated with the telephone number via a wireless network.

In accordance with an embodiment, a second message addressed to a second telephone number associated with the user is received. Subscriber information associated with the second telephone number is retrieved. Based on the subscriber information, it is determined that the second telephone number is device specific and associated with a mobile device. The second message is transmitted to the mobile device via a mobile communication network.

In accordance with an embodiment, a third message sent by the client running on the mobile device is received via the wireless network. The third message is addressed to a telephone number associated with a second user. A messaging server transmits the third message to a messaging server for delivery to a second device having the telephone number associated with the second user.

In accordance with an embodiment, the third message is transmitted via the messaging server to a messaging service application programming interface. The message is stored via the message service application interface in network storage.

In accordance with an embodiment, the first message comprises a multimedia messaging service message.

In accordance with an embodiment, a request to clear all messages addressed to the telephone number associated with the user is received. The request is transmitted to the client to clear all the messages addressed to the telephone number associated with the user without affecting messages addressed to the second telephone number associated with the user.

In accordance with an embodiment, a first persona is associated with the telephone number associated with the user and a second persona is associated with the second telephone number associated with the user.

These and other advantages of the invention will be apparent to those of ordinary skill in the art by reference to the following detailed description and the accompanying drawings.

### BRIEF DESCRIPTION OF THE DRAWINGS

FIG. 1 depicts a message communication system, in accordance with an embodiment;

FIG. 2 depicts functional and structural components of an exemplary user device, in accordance with an embodiment;

FIG. 3 depicts functional components of a messaging network, in accordance with an embodiment;

FIG. 4 depicts functional components of a telephone number information system, in accordance with an embodiment;

FIG. 5 depicts functional components of a message handling infrastructure, in accordance with an embodiment;

FIG. 6 depicts functional components of a persona based messaging infrastructure, in accordance with an embodiment;

FIG. 7 is a flowchart of a method of receiving a message by a user having multiple personas, in accordance with an embodiment;

FIG. 8 is a flowchart of sending a message by a user having multiple personas, in accordance with an embodiment;

FIGS. 9A and 9B depict graphical user interfaces displaying how a message is sent by persona based messaging client, in accordance with an embodiment;

FIGS. 10A and 10B depict additional graphical user interfaces displaying how a message is sent from a contacts interface, in accordance with an embodiment; and

FIG. 11 illustratively depicts components of a computer that may be used to implement various embodiments.

### DETAILED DESCRIPTION

In the past, a corporation would provide an employee with a separate business-dedicated device (e.g., a smartphone, a tablet, a laptop, etc.) having a separate voice/data plan so that the employee could access business related communication. Not only did this incur additional cost for the corporation, but it was cumbersome for the employee to have to carry a separate business device. In order to send business-related messages, the employee could utilize the native messaging functionality provided with the business device.

In order to combine the security and peace of mind of using a business-dedicated device with the convenience of BYOD, it is desirable to have a device that has an application allowing users to function on one device as if they had two devices, a personal device as well as a business or corporate device. Installation of the application creates a secure workspace on a personal device. This allows a remote administrator to encrypt and secure corporate data on a personal device. By using the application, a secure framework is used to route telephone calls to a business persona and a personal persona of a corporate employee. In order to send and receive messages to the business persona provided by the application, a client is used. The business persona of the employee (or a first persona of the employee) is associated with a business telephone number and the personal persona of the employee (or a second persona of the employee) is associated with the employee's personal telephone number. The personal persona and the business persona can be accessed on a single device but are separate from one another.

In another embodiment, the application can be installed on a business device and provide a business persona and one or more additional personas. An additional persona may be a personal persona. This would allow the employee using the device to separate out his/her personal communication from the business communication. The employee may be granted administrative rights in order to access his personal persona. This way, the company would have access to the business device and communication without being able to access other personas. In an embodiment, it may be beneficial to set up a business device in this manner and allow one or more employees to access their personal persona(s) on the business device, while maintaining privacy and security of their personal communication

SMS/MMS messages can be sent or received on a separate business number on the same device that the employee uses for personal or consumer purposes. If the employee misplaces his/her device or leaves the company, a remote IT administrator can purge the corporate data while not being able to access or touch any personal information on the device.

The business persona is assigned a second mobility number, where messages received on that second mobility number can be accessed only by the business persona.

Messaging services over SMS/MMS protocols are provided to the secondary number (associated with the business persona). In this way, business users are able to use a reliable messaging service for a second business number that can be accessed on their personal device(s). To access messaging services using the second telephone number, a graphical user interface is provided to receive and send messages. The messages interact with a series of network Application Programming Interfaces (APIs) to route messages over a mobile network. The mobile network is utilized thus enabling sending and receiving of SMS and MMS messages to any valid mobile device number. Messages are communicated between the employee associated with the business persona and other users, regardless of what mobility carrier the other users are subscribed to.

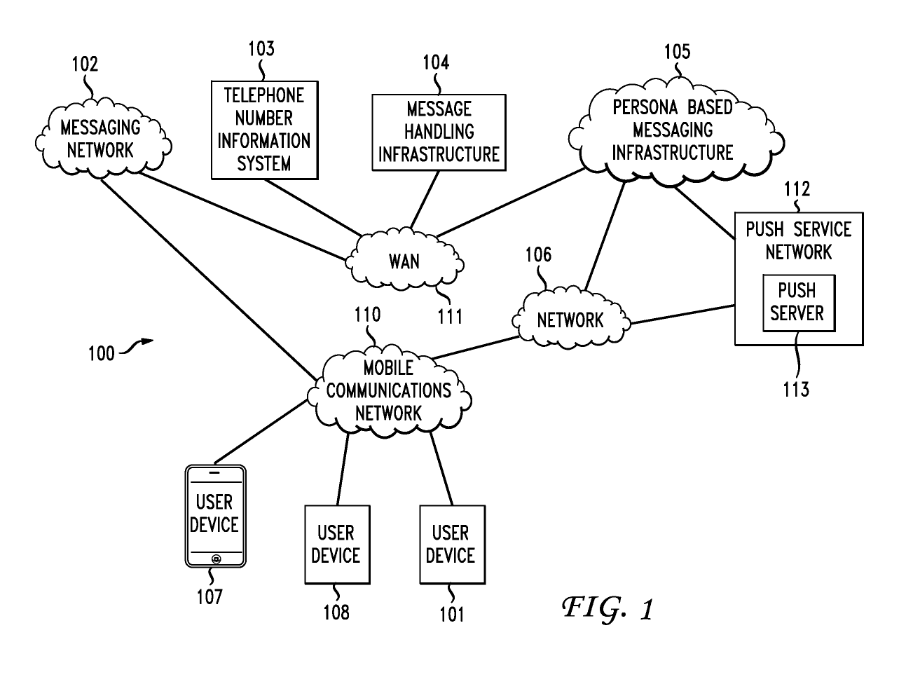

FIG. 1 depicts a message communication system, in accordance with an embodiment. Message communication system 100 includes a user device 101, a messaging network 102, a telephone number information system 103, a message handling infrastructure 104, a persona based messaging infrastructure 105, a network 106, a user device 107, a user device 108, a mobile communications network 110, a wide area network (WAN) 111, and a push service network 112. Push service network 112 includes a push server 113. Message communication system 100 may include fewer or additional user devices than those depicted in FIG. 1.

In the exemplary embodiment of FIG. 1, network 106 is the Internet. In other embodiments, network 106 may include one or more of a number of different types of networks, such as, for example, a virtual private network (VPN) over the Internet. Other networks may be used. Alternatively, network 106 may include a combination of different types of networks. In the exemplary embodiment of FIG. 1, WAN 111 is depicted. However, other network types may be used instead. For example, an intranet, a local area network (LAN), a wide area network (WAN), a wireless network, a Fibre Channel-based storage area network (SAN), or Ethernet may be used.

Persona based messaging infrastructure 105 may be connected to network 106 through a direct (wired) link, or wirelessly. Any of user devices 101, 107, and/or 108 may be connected to network 106 via mobile communications network 110. Any of user devices 101, 107, and/or 108 may have a respective display screen for displaying information. For example, any of user devices 101, 107, and/or 108 may be a personal computer, a laptop computer, a workstation, a mainframe computer, a mobile communication device such as a wireless phone, a smartphone, a personal digital assistant, cellular device, a laptop computer, a netbook, a tablet device, a wearable device, etc. Other devices may be used.

Other connections may optionally be made with network 106. Any of user device 101, messaging network 102, and/or message handling infrastructure 104 may be connected to network 106 through a directed (wired) link, or wirelessly.

Mobile communications network 110 in FIG. 1 communicates directly with messaging network 102. Message handling infrastructure 104, persona based messaging infrastructure 105, and telephone number information system 103 communicate via WAN. In an embodiment, mobile communications network 110 may be a communication network providing cellular services. Mobile communications network 110 may be a code division multiple access (CDMA) network or a global system for mobile communications (GSM) network.

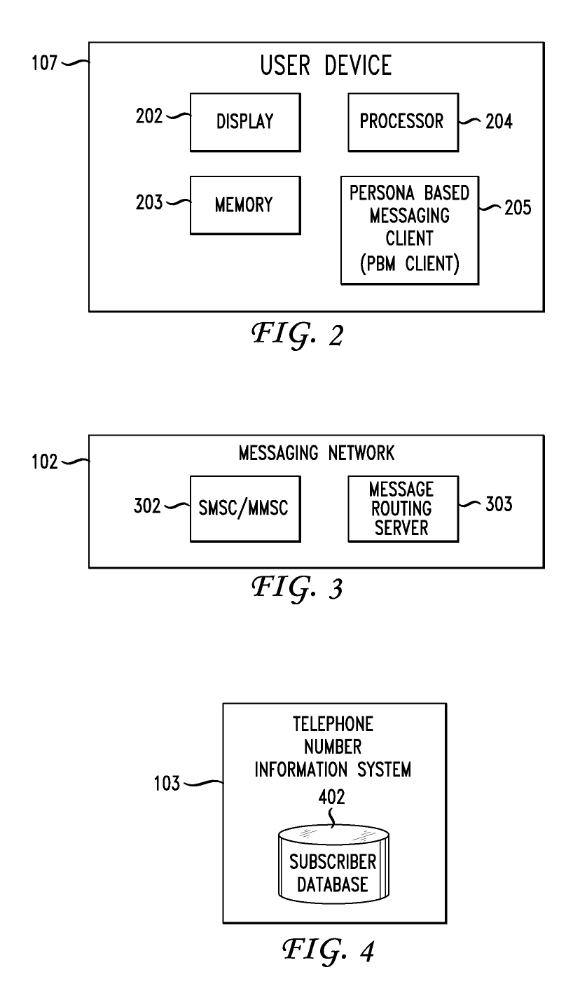

FIG. 2 depicts functional and structural components of an exemplary user device, in accordance with an embodiment. User device 107 includes a display 202, a memory 203, a processor 204, and a persona based messaging client 205. Display 202 provides display of graphical user interfaces, messages such as emails, SMS or MMS messages, documents, text, images, videos, webpages, and other information. In an embodiment, user device 107 includes a native SMS/MMS client (not shown) that is used to read non-persona based messages addressed to user device 107. In an embodiment, a persona based messaging client 205 is available for download onto user device 107 using an application store. User device 107 is capable of being connected to the Internet.

When persona based messaging client 205 is installed on user device 107, user device 107 registers with a messaging server in persona based messaging infrastructure 105.

Memory 203 may store local data including an address book/contact information associated with user device 107. In another embodiment (not depicted), an address book may be stored in a subscriber identity module (SIM) card.

Although FIG. 2 depicts user device 107, user device 101 and/or user device 108 may include similar components to those shown in user device 107 in FIG. 2. In the depicted embodiment, user device 107 is depicted as a mobile device. However, any of user devices 101, 107, and/or 108 may be mobile devices or other types of devices.

FIG. 3 depicts functional components of a messaging network, in accordance with an embodiment. Messaging network 102 includes a short message service center (SMSC) or a multimedia message service center (MMSC), depicted as an SMSC/MMSC 302. SMS messages are dealt with by the SMSC while MMS messages are dealt with by the MMSC. Therefore, SMSC and MMSC are two separate entities and each deals with a respective message format (e.g., SMS or MMS). A message routing server 303 is also included in messaging network 102.

FIG. 4 depicts functional components of a telephone number information system 103, in accordance with an embodiment. Telephone number information system 103 includes a subscriber database 402. Subscriber database 402 lists subscriber information such as a device type, services subscribed to by the subscriber, and telephone numbers associated with the subscriber. Subscriber database 402 maps a telephone number to a device and/or a set of services available to that telephone number. The subscriber database also provides information regarding whether a telephone number is an actual number that is device specific (for example, a telephone number associated with an employee's personal persona) or not. A telephone number is not device specific when the telephone number is associated with a persona based messaging service (for example, a telephone number associated with an employee's business persona). A persona based messaging service is a system of components that enable over-the-top messaging content to utilize the mobility network to deliver SMS/MMS messages to a user on one or more devices, regardless of the cellular capabilities of the one or more devices. A device specific telephone number is tied to a particular device that has a SIM card. A device specific telephone number is assigned to the SIM card. A telephone number that is not tied to a particular device or assigned to a SIM card but is instead associated with a persona based messaging service and is tied to the persona based messaging service instead of being tied to a device. In other words, the telephone number associated with a persona based messaging service is tied to a service and not tied to a specific device. Messages sent to the telephone number associated with the persona based messaging service can be received via a persona based messaging client on any device. If a message is addressed to a telephone number associated with a persona based messaging service, then that message can be delivered to a persona based client on one or more devices and is free of being assigned to a particular device's SIM card. In an embodiment, the subscriber database lists whether a telephone number is associated with a persona based messaging service or device specific, such as a mobile telephone number assigned to a SIM card of a mobile device. In an embodiment, a telephone number that is associated with a persona based messaging service is a soft telephone number, such as a voice over Internet protocol (VoIP) telephone number.

In an embodiment, an IT administrator can configure and assign a business telephone number to a user (e.g. an employee). The administrator can do so by requesting a new number or port an existing number that is assigned as the user's business number. When the new number is assigned, subscriber database 402 is updated accordingly.

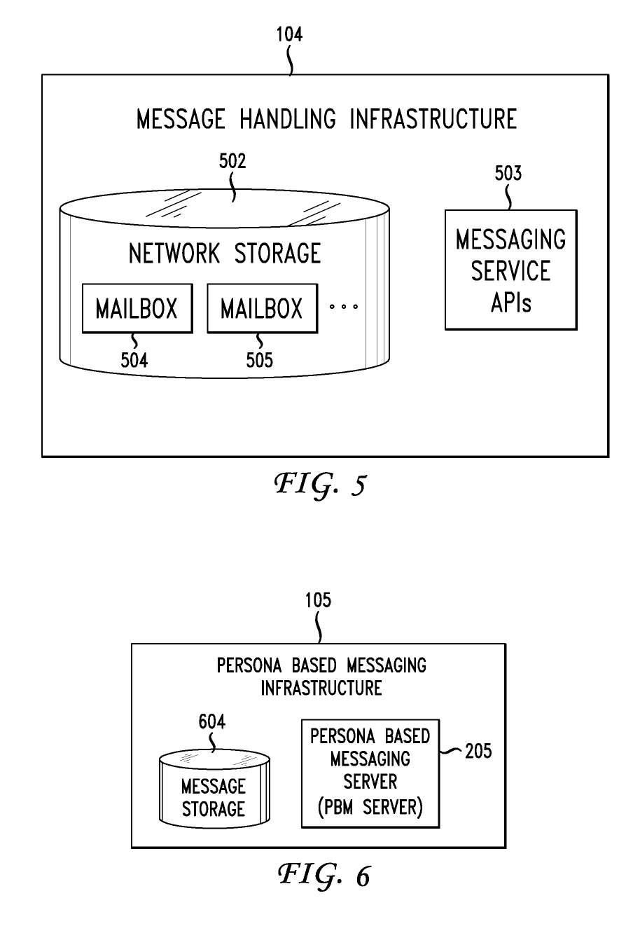

FIG. 5 depicts functional components of a message handling infrastructure, in accordance with an embodiment. Message handling infrastructure 104 includes network storage 502 and messaging service APIs 503. Network storage 502 includes mailboxes associated with respective users. For example, mailbox 504 is a mailbox associated with a first user and mailbox 505 is a mailbox associated with a second user. Each mailbox is unique and stores information (e.g. outgoing and incoming SMS or MMS messages, etc.) that is routed to/from a user's telephone number (e.g., a business telephone number).

FIG. 6 depicts functional components of a persona based messaging infrastructure. Persona based messaging infrastructure 105 includes a persona based messaging server (PBM server) 602, and a message storage 604. Message storage 604 stores messages. For example, message storage 604 may store messages associated with a user's persona. The messages may be incoming or outgoing messages.

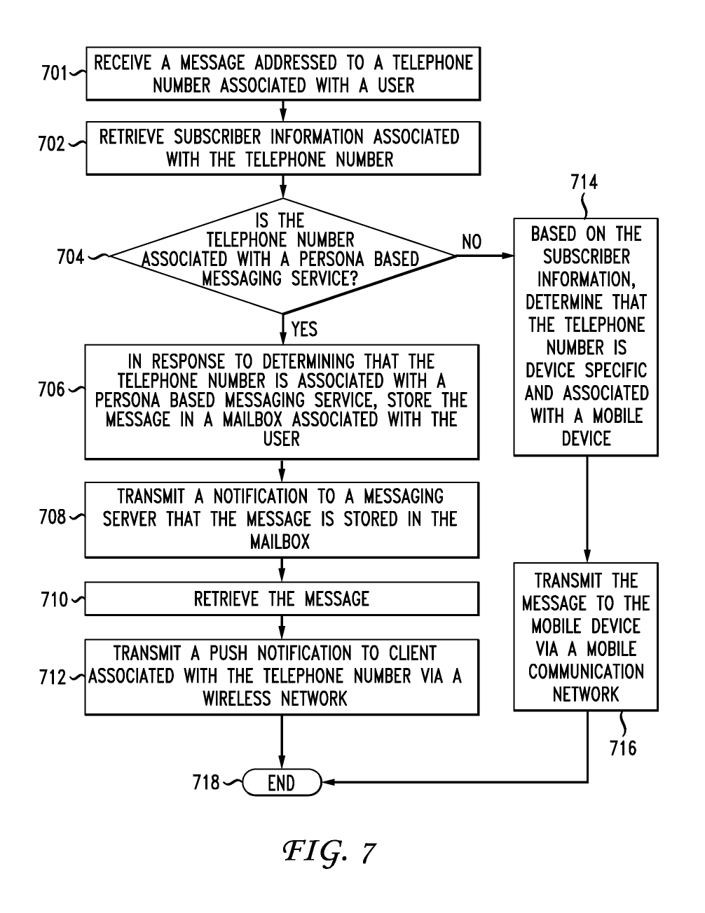

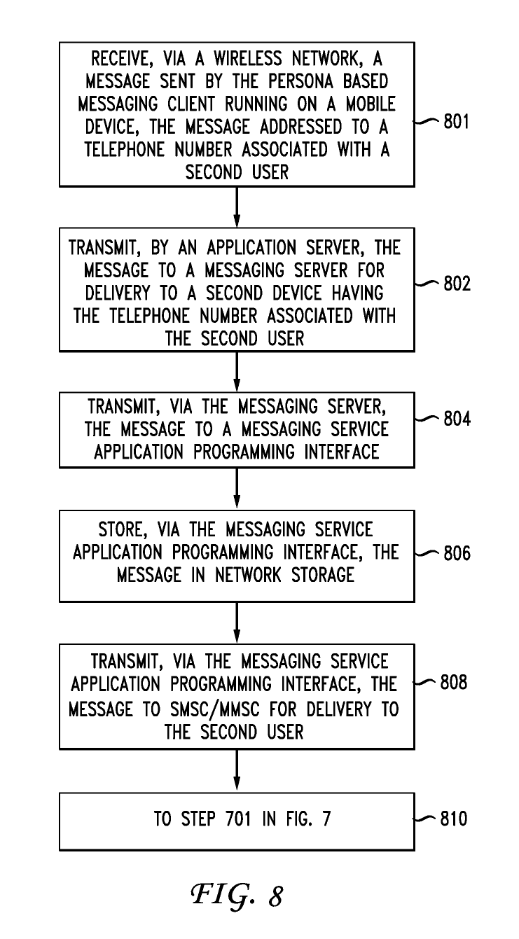

FIG. 7 is a flowchart of a method of receiving a message by a user having multiple personas, in accordance with an embodiment. Suppose that Benson D. is a user employing user device 101 and that Benson D. wishes to send a message to Bob. Bob is a user that has multiple personas, where each persona is associated with a respective telephone number. Suppose that Bob has a business telephone number that is associated with his business persona. Benson D. may send a message to Bob's business telephone number. In an embodiment, Benson D. is unaware that Bob's business telephone number is associated with a persona based messaging service (i.e., a virtual number associated with his business persona), and sends a message from his device as he would to any other mobile telephone number.

Benson D. sends a message, via user device 101, to Bob. Benson D. may use a conventional messaging interface and/or a native messaging client in order to submit the message. In an embodiment, the message is in the form of an SMS or MMS message. Benson D. sends an SMS message in a similar manner as an MMS message. In an embodiment, if Benson D. wishes to send a short (e.g. 160 characters or less), text only message to a single recipient (i.e., Bob), a messaging client on Benson D.'s device determines to send an SMS message. If Benson D. chooses to send a group message or send a multimedia attachment (e.g., a picture) with the message, the messaging client determines to send an MMS message.

In FIG. 7, at step 701, a message addressed to a telephone number associated with a user is received. Messaging network 102 receives the message. If the message is in the form of SMS text message, SMSC 302 receives the message. If the message is in the form of an MMS text message, MMSC 302 receives the message. Although SMSC or MMSC performs various steps described herein, the acronym SMSC/MMSC 302 is used to describe the steps performed by either one of SMSC or MMSC. Therefore, whenever the message is in the form of an SMS message, it is SMSC performing a particular function and whenever the message is in the form of an MMS, it is MMSC performing a particular function. In an embodiment, messaging network 102 may determine whether the message is in the form of an SMS or an MMS. Messaging network 102 may view header information of the message in order to determine the message type.

At step 702, subscriber information associated with the telephone number is retrieved. Message routing server 303, which is in communication with SMSC/MMSCM 302, in messaging network 102 queries telephone number information system 103 in order to obtain subscriber information (e.g., information regarding a device and/or services). For example, message routing server 303 may ask telephone number information system 103 to check subscriber database 402 for information regarding the telephone number (associated with Bob) that Benson D. addressed the message to. Message routing server 303 includes logic used to determine whether the message should be forwarded to a device or to message handling infrastructure 104 based on the telephone number type (i.e., whether the telephone number is device specific or associated with a persona based messaging service). Subscriber database 402 lists the telephone number as being associated with Bob, services Bob has subscribed to, and a telephone number type. Subscriber database 402 also informs message routing server 303 whether or not the telephone number is associated with a persona based messaging service or not. For example, subscriber database 402 may list the telephone number as being associated with a persona based messaging service. This information is returned back to SMSC/MMSC 302 of messaging network 102.

At step 704, it is determined whether the telephone number is associated with a persona based messaging service. Based on the information obtained in step 702, message routing server 303 determines whether the telephone number is associated with a persona based messaging service. Message routing server 303 determines whether to route the message based on the telephone number being associated with a persona based messaging service or device specific. Message routing server 303 can also determine that the telephone number is a soft number or virtual number if the telephone number is associated with a persona based messaging service. As described above, in an embodiment, Benson D. is unaware of the telephone number associated with Bob being associated with a persona based messaging service. As far as Benson D. is concerned, he sends the message to Bob as he would send any other message.

At step 706, in response to determining that the telephone number is associated with a persona based messaging service, the message is stored in a mailbox associated with the user. In response to message routing server 303 determining that the telephone number is associated with a persona based messaging service, message routing server 303 store the message in a mailbox associated with a user. In an embodiment, an attribute obtained from telephone number information system 103 (in step 702) informs message routing server 303 to store a copy of the message. Message routing server 303 archives the copy of the message in network storage 502 in message handling infrastructure 104. Each user is assigned a unique mailbox in network storage 502. The user Bob may be assigned mailbox 504. Therefore, all messages associated with Bob (sent to a business persona associated with Bob) are stored in mailbox 504. In an embodiment, the messages in mailbox 504 are separately stored based on a telephone number. Suppose Bob has multiple personas that are each assigned respective telephone numbers associated with a persona based messaging service. As such, all messages sent to Bob's business persona are stored separate from messages sent to Bob's other persona(s) based on the respective telephone numbers of the personas. In another embodiment, a single mailbox may only hold messages for a single dedicated persona.

At step 708, a notification is transmitted to a messaging server that the message is stored in the mailbox. Messaging service APIs 503 (which are in communication with network storage 502) in persona based messaging infrastructure 105 send a notification to persona based messaging server (PBM server) 602 to inform PBM server 602 that the message is stored in mailbox 504 for a specific telephone number. The telephone number is associated with mailbox 504. In an embodiment, the notification message may be sent using 1-way or 2-way Transport Layer Security (TLS).

At step 710, the message is retrieved. PBM server 602 receives the notification and retrieves the message. 1-way or 2-way TLS may be used to retrieve the message.

PBM server 602 retrieves the message and places the message into message storage 604.

In an embodiment, PBM server 602 subscribes to receive messages for each number that is associated with a secondary persona (e.g., a business persona). Therefore, in step 708, a notification is only sent by network storage 502 for telephone numbers that PBM server 602 subscribes to.

At step 712, a push notification is transmitted to a client associated with the telephone number via a wireless network. PBM server 602 receives the message for Bob's telephone number, and based on the number, PBM server 602 determines which devices Bob has registered clients installed on. PBM server 602 sends a push notification, via push server 113 of push service network 112, to a client (e.g., PBM client 205 in user device 107), via network 106 (e.g., the Internet), where the client can receive messages addressed to the telephone number (associated with a persona based messaging service). The push notification is transmitted via push service network 112 and network 106. If there are multiple PBM clients, all of the registered PBM clients are sent the push notification. Therefore, the push notification is sent to one or more PBM clients running on respective mobile devices. When Bob opens a PBM client (after logging into the client) on one of the devices (e.g., PMB client 205 on user device 107) that has the client registered, the client downloads all new messages from PBM server 602. In an embodiment, PBM server 602 transmits the message to PBM client 205 (executed and/or running on user device 107), via push service network 112 and network 106. In another embodiment, PBM server 602 can transmit the message to multiple clients that are running on multiple devices, via push service network 112, which pushes the message to respective clients running on user device 107 and user device 108, via network 106. For example, the message may be transmitted to PBM client 205 running on user device 107 via push service network 112 and network 106, an application PBM client running on user device 108, via push service network 112 and network 106, etc.

In an embodiment, the message includes a header and payload. Based on the information included in the header, PBM server 602 can verify that the message is to be sent to one or more persona based messaging clients accessed by Bob to receive messages addressed to the telephone number associated with his business persona.

In an embodiment, the persona based messaging client is password-protected so that only Bob is authorized to access it and incoming messages.

Bob logs into the PBM client (i.e., PMB client 205) and the PBM client retrieves all new messages from the PMB server (i.e., PBM server 602) and then provides the message(s) to Bob. Bob may review the message on a display shown as a graphical user interface within the persona based messaging client.

The process ends at step 718.

Referring back to step 704, suppose now that it is determined that the telephone number is not associated with the persona based messaging service and is addressed to a telephone number that is for a specific mobile device, the process continues on to step 714. The following provides an example encompassing this embodiment.

Suppose that a second message addressed to a second telephone number associated with a user is received at step 701. Messaging network 102, specifically, SMSC/MMSC 302 receives the message.

At step 702, subscriber information associated with the second telephone number is retrieved. Message routing server 303 in messaging network 102 queries telephone number information system 103 in order to obtain subscriber information associated with the second telephone number in a similar manner as described above.

At step 704, it is determined whether the second telephone number is associated with a persona based messaging service. Based on the information obtained in step 702, message routing server 303 determines whether the second telephone number is associated with a persona based messaging service.

If it is determined that the second telephone number is not associated with the PBM service, at step 714, based on the subscriber information, it is determined that the second telephone number is device specific and associated with a mobile device (i.e., the second telephone number is assigned to a SIM card).

For example, suppose that a message is sent to Bob's personal persona. In this case, a message addressed to Bob's personal persona is device specific (i.e., associated with user device 107) and based on the telephone number, it is determined that the message is addressed to a specific device.

At step 716, the second message is transmitted to the mobile device via a mobile communication network. Message routing server 303 transmits the second message to a mobile device (user device 107) via mobile communications network 110.

The user then reads the message using the native messaging client (MMS or SMS client) on the user device (not shown).

The process ends at step 718.

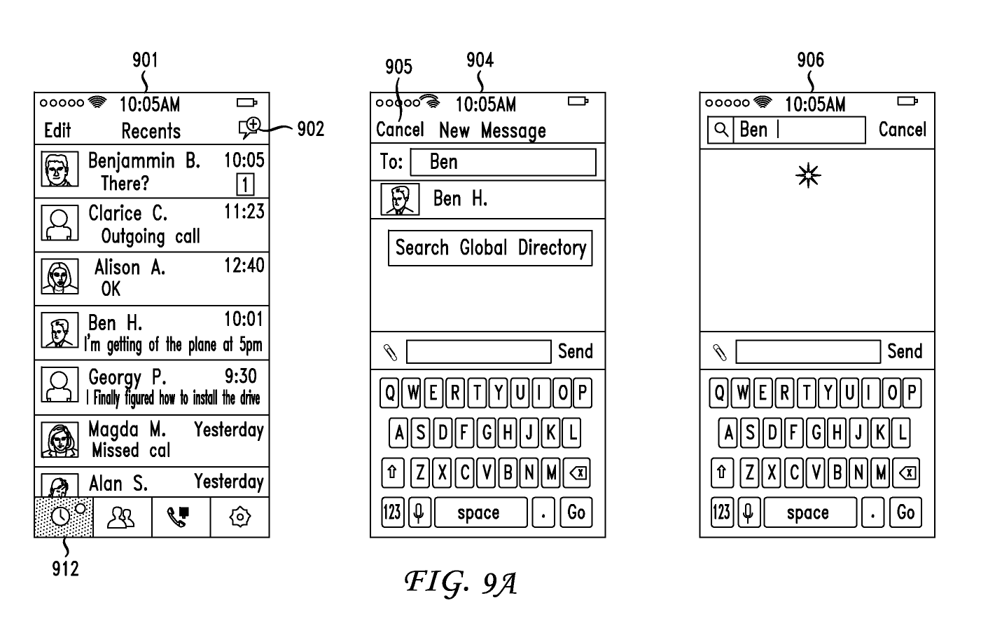

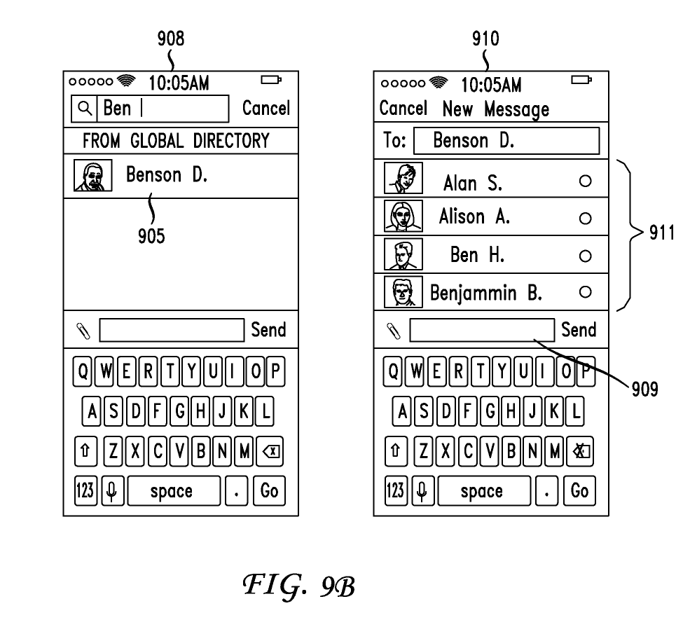

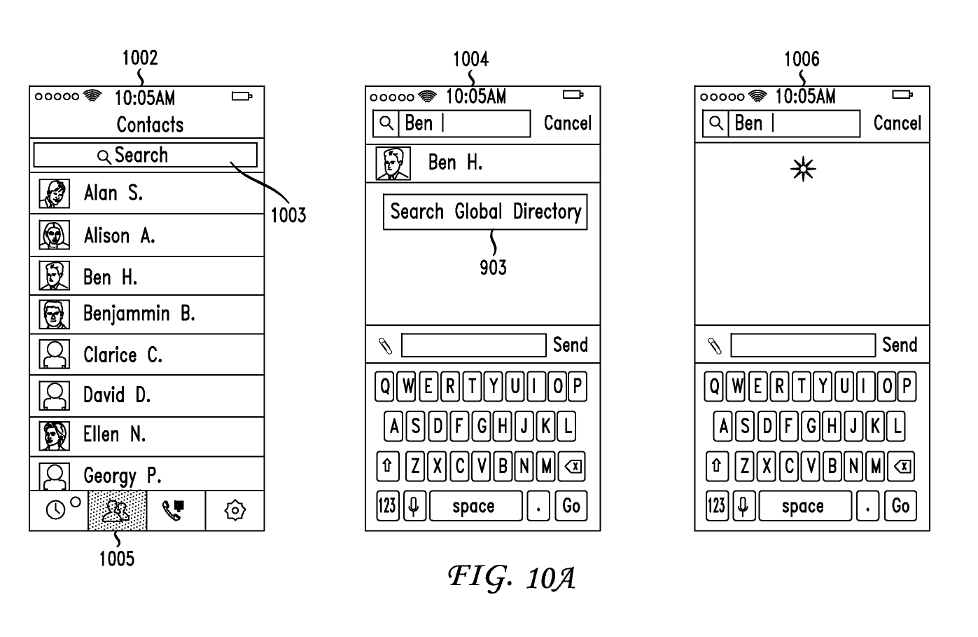

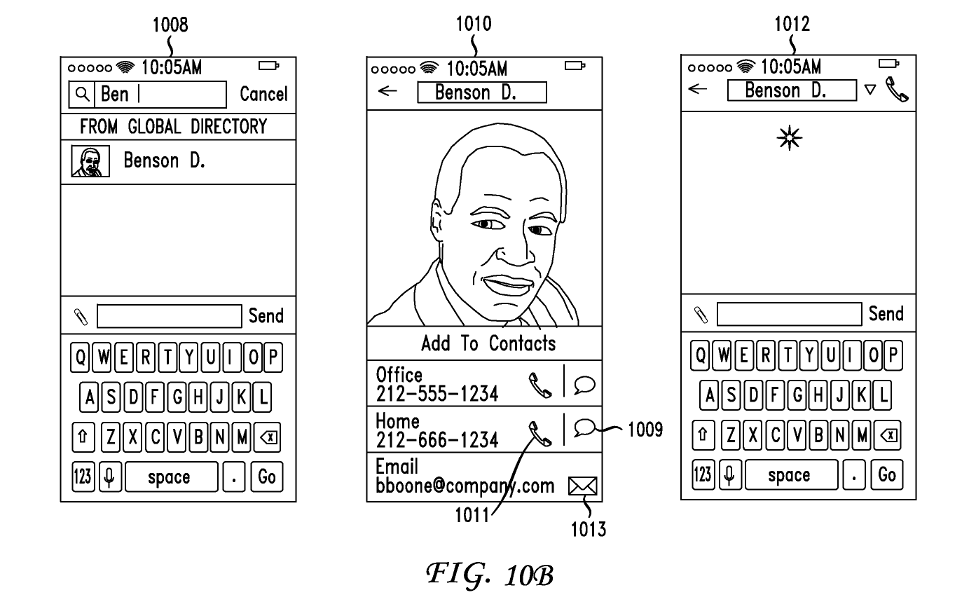

Referring again to the example provided above with respect to FIG. 7, suppose that Bob receives the SMS or MMS message from Benson D. and wishes to reply. Bob can do so by employing PBM client 205 executed on user device 107. Details regarding how Bob sends the message using a graphical user interface are described herein with respect to FIGS. 9, 10A and 10B. When Bob sends out the message using PBM client 205, the message received by Benson D.'s device shows as being transmitted by Bob's business telephone number (e.g., a secondary telephone number associated with Bob's business persona). Benson D. is not aware that Bob uses a persona based messaging client to send out a message. The message appears to Benson D. to be the same as a message that originated from a mobile device using a native messaging client having native message functionality. Details regarding how the message is routed are described with respect to FIG. 8.

FIG. 8 is a flowchart of sending a message by a user having multiple personas. At step 801, a message sent by the persona based messaging client (PBM client) running on a mobile device is received via a wireless network. The message is addressed to a telephone number associated with a second user. Bob, utilizing any mobile device (e.g., user device 107 or user device 108) sends a message by PMB client 205 running on the mobile device, via a wireless network, by selecting a “send” command on his mobile device. The wireless network may be network 106. In another embodiment, the wireless network may be another network. The message sent by PMB client 205 is received by PBM server 602 of persona based messaging infrastructure 105, via network 106. For example, the message may be a multimedia message with an attached picture or a text message. In another embodiment, a different protocol may be used to send the message.

Since the message is sent in the form of data, data packets are transmitted to PBM server 602. Therefore, the message is a data message at this point and not a specific SMS or MMS message. In an embodiment, communication of the data message from PMB client 205 to PMB server 602 (and all communications between PBM client 205 and PBM server 602) is sent via secure protocol TLS. PBM server 602 determines whether a message should be an SMS or MMS message and leverages an appropriate API call accordingly to transform the data packets into an SMS or MMS message format.

PBM server 602 stores a copy of the message in message store 604 before transmitting the message out.

At step 802, the message is transmitted by the messaging server to a message network for delivery to a second device having the telephone number associated with the second user. PBM server 602 transmits the message for delivery to user device 101 having the telephone number associated with the second user (i.e., Benson D.). The specifics of how the transmission is completed are described herein with respect to the following steps.

At step 804, the message is transmitted, via the messaging server, to a messaging service application programming interface. The message is transmitted, via PBM server 602, to messaging service APIs 503. Messaging service APIs 503 may include one or multiple application programming interfaces. In an embodiment, PBM server 602 determines a type of message that should be sent. That is, PBM server 602 determines whether the message should be sent as an MMS or an SMS and PBM server 602 calls a corresponding API based on the type of message. In an embodiment, a direct connection may be used between persona based messaging infrastructure 105 and message handling infrastructure 104 to transmit the message. In another embodiment, the message may be communicated using a network such as mobile communication network 110 or network 106. In yet another embodiment, the message may be communicated using WAN 111 and is not accessible via other networks (e.g., the Internet or mobile communication network). 1-way or 2-way TLS or Session Initiation Protocol (SIP) may be used to transmit the message.

At step 806, the message is stored via the messaging service application programming interfaces in network storage. The message is stored via messaging service APIs 503 in network storage 502. The message may be stored in mailbox 504, which is a unique mailbox associated with the user. All incoming and outgoing messages associated with Bob are stored in mailbox 504. All messages are appropriately formatted as either SMS or MMS format.

At step 808, the message is transmitted, via the messaging service application programming interface, to SMSC/MMSC for delivery to the second user. The message is transmitted via messaging service APIs 503 to SMSC/MMSC 302 for delivery out to the second user. In an embodiment, if the message is an SMS message, SMSC handles the message and if the message is an MMS message, MMSC handles the message. In step 810, the flowchart then returns to step 701 in FIG. 7.

FIGS. 9A and 9B depict graphical user interfaces displaying how a message is sent by PMB client, in accordance with an embodiment. Bob selects PMB client 205 that runs (or is already running) on user device 107. Bob may click on an icon, send a voice command by speaking into a microphone connected to user device 107, use a Bluetooth-enabled device to select the PMB client, or use other means to select and/or open the PMB client. Once the PMB client is opened, Bob views interface 901, shown in FIG. 9A. Bob can create a new message (or send a reply message to Benson D.'s message). In an embodiment, the new message can be sent to a single contact or a group of contacts. A message sent to single contact can be in the form of an SMS or an MMS message where as a message sent to a group of contacts is in the form of an MMS message. In the depicted embodiment, Bob selects icon 902 to create the message.

Upon selection of the icon, Bob is provided with interface 904. Bob can type in a few letters of the name or a partial or entire telephone number of the person he wishes to send the message to. As shown, Bob types in “Ben” in the “To:” field in a search textbox 913 in interface 904. In the depicted embodiment, Bob is provided with the contact “Ben H.” shown in interface 904. In an embodiment, the search is limited to a local directory saved on Bob's device. For example, the search may only display contacts that have recently contacted Bob or contacts that are stored on Bob's device. However, since Bob wishes to send the message to Benson D. who may not be saved in Bob's local directory, Bob must search the global directory. Bob selects the search global directory link 903, which opens up all contacts in the global directory of the company Bob works for. The string that was entered in the search textbox (“Ben”) is prepopulated into the global directly search textbox, as shown in interface 906. The search results are then provided in interface 908 in FIG. 9B. Bob then selects Benson D. by clicking on (or otherwise selecting) Benson D.'s contact icon 905. Bob's device then displays interface 910 in which Bob is provided an opportunity to select additional contacts, should he wish to send a group message. Again, Bob can perform a Global Address List (GAL) lookup using the global directory. In an embodiment, one or more characters, letters, symbols, etc., may be used to initiate a search. In an embodiment, at least four characters are used to trigger the GAL lookup. For each additional user, Bob may be returned to interfaces 901, 904, 906, and 908 until the proper contact is found.

When provided with interfaces 904, 906, 908, or 910, Bob can select the “Cancel” icon. For example, in interface 904, Bob can select cancel icon 905. Upon selection of the cancel icon, no contacts are added to the list of contacts to send the message to and Bob is brought back to interface 901.

In interface 910 in FIG. 9B, after Bob selects Benson D. and any other contacts he wishes to send the message to, Bob can type the message into text field 909. Bob can also attach a multimedia file, such as a picture file to attach to the message by clicking on the paperclip icon in interface 910.

In the depicted embodiment of interface 910, selection of Benson D. may provide a group of contacts instead of an individual contact. For example, Alan Sykes, etc. may all be included in the Benson D. group. Bob can also select individual contact(s) by selecting the radio buttons 911 adjacent the respective contact icons.

After Bob sends the message to the group of contacts and an acknowledgement is received that the group received the message, the message is then stored as a recent conversation. An example of an interface providing a list of recent conversations is shown in interface 901. To return to an interface depicting recent conversations, a user can select icon 912, as shown in interface 901.

In an embodiment, a default setting of the PMB client provides Bob with the global contacts interface upon selection of the search global directory link 903. In another embodiment, Bob may be provided with a different interface.

Suppose that Bob is viewing a different interface than interface 901 when he wishes to compose and send a message using PMB client 205. FIGS. 10A and 10B depict additional graphical user interfaces displaying how a message is sent from a contacts interface, in accordance with an embodiment. Suppose that Bob wishes to view a contacts interface. Bob can select contacts icon 1005 and is provided with interface 1002. In search field 1003, Bob can enter a partial or complete name or telephone number. Suppose Bob enters the name Ben into the search field. Upon entering the letter “B” into the search field, interface 1004 is displayed to Bob. Bob then continues to type out “Ben”. In interface 1004, the search results yield the contact for “Ben H.” However, as described above with respect to FIGS. 9A and 9B, Bob wishes to find the contact Benson D. Therefore, Bob selects the search global directory link 903, which opens up all contacts in the global directory of the company Bob works for. The string that was entered in the search textbox (“Ben”) is prepopulated into the global directly search textbox, as shown in interface 1006. The search results are then provided in interface 1008, shown in FIG. 10B. Bob then selects Benson D. by clicking on (or otherwise selecting) Benson D.'s contact icon 1009. Bob's device then displays interface 1010 in which a contact card associated with Benson D. is displayed. The contact card provides options such as a message option, a call option, an email option, etc. based on the information available for the particular contact, in this case Benson D. Upon selection of message icon 1009, a message addressed to Benson D.'s home telephone number can be composed. Interface 1012 provides a display of a compose message screen.

Other icons depicted in interface 1010 within the contact card provide additional functionality. For example, call icon 1011 allows placement of a telephone call to Benson D.'s home telephone number. Email icon 1013, when selected, provides an email composition interface. Selection of cancel icon 1014 (in interface 1008) returns a user back to interface 1002 to the contact search. Additionally, a user may be provided with an option to add a contact and save the contact locally on the user device. The contact may also be saved globally.

Although two personas-a business and personal persona are used in the embodiments described above, it is understood that these personas are exemplary embodiments only. A particular user may be associated with additional personas. In addition, although the terms business and personal personas are used, they are not meant to be limiting. For example, a user may have multiple personas that are all business related or a combination of various personas.

In an embodiment, a first persona is associated with a first telephone number associated with a user. The first persona may be a business persona and the first telephone number may be a soft telephone number. A second persona is associated with a second telephone number associated with the user. The second persona may be a personal persona and the second telephone number may be connected to a particular SIM card than is inserted into a device.

An enterprise business service is provided that creates a secure workspace on a personal mobile device of the employee (e.g., a smartphone, a tablet, a laptop, etc.). An IT administrator can control the secure workspace portion of the mobile device remotely, while the personal side of the device is left unseen to the enterprise. The mobile device is split into two personas—a business persona with enterprise control over the business side and a personal persona with personal control over the personal side. Each of the personas can send and receive messages independent of each other.

Framework used to provide communication to/from the business persona is built to act as a secure messaging service within the construct of a secure persona. In addition, the secure messaging services enables business communications to occur on a separate and distinct business number provided by the enterprise on the same device(s) as an employee's personal service. However, the business communications are secured and able to be remotely wiped by an administrator if the need arises. This in turn protects corporate message data from leakage due to theft, loss of device, or employee misuse. By utilizing a mobile network, the secure messaging system has commercial benefits as a separately marketed solution that may be added on to already existing enterprise business services. Any platform, regardless of the carrier/owner, can utilize the secure messaging service.

Therefore, a secure service is provided that uses the mobility network to communicate messages to a separate business number associated with an employee where the messages can be remotely controlled by an enterprise administrator. The messages are text and/or multimedia messages that are addressed to and sent from the separate business number associated with an employee. In another embodiment, voice calls can be routed to the separate business number for receipt by the user employing a mobile device.

Suppose that the administrator wishes to wipe some or all data addressed to a user's business telephone number (associated with the user's business persona). The administrator can send a request to clear all messages that are addressed to the telephone number associated with the user. The request to clear all messages is received by PBM server 602 in persona based messaging infrastructure 105. PBM server 602 transmits the request to the PMB client to clear all of the messages that are addressed to the telephone number associated with the user. The messages that are addressed to the second telephone number (associated with the user's personal persona) remain unaffected by the request. This way, the administrator can wipe all business content off without touching the personal messages, etc. that are stored on the user's device. In another embodiment, PBM server 602 transmits the request to all instances of PMB clients running on user devices that are accessed by the user to clear all the messages. This way, all copies of the messages are purged.

The administrator may also push policies, data, documents, emails, etc. to the PMB client(s). Therefore, updating of policies, firmware, etc. can be performed remotely by the administrator without affecting the personal personas of the user's device(s).

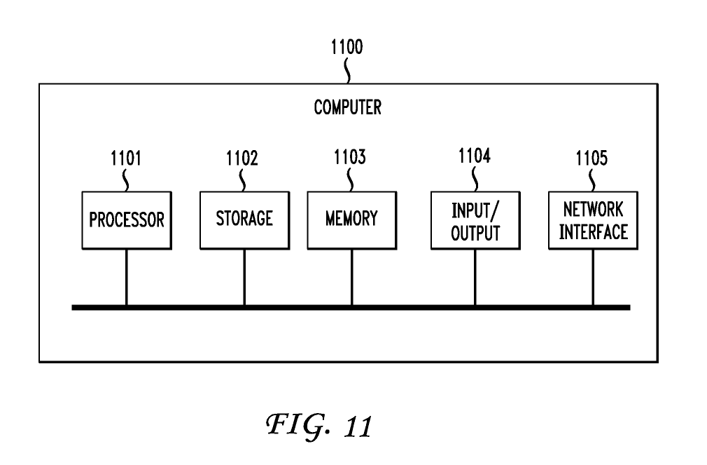

A high-level block diagram of an exemplary computer that may be used to implement systems, apparatus and methods described herein is illustrated in FIG. 11. Computer 1100 includes a processor 1101 operatively coupled to a data storage device 1102 and a memory 1103. Processor 1101 controls the overall operation of computer 1100 by executing computer program instructions that define such operations. The computer program instructions may be stored in data storage device 1102, or other computer readable medium, and loaded into memory 1103 when execution of the computer program instructions is desired. Thus, the method steps of FIGS. 7 and 8 can be defined by the computer program instructions stored in memory 1103 and/or data storage device 1102 and controlled by the processor 1101 executing the computer program instructions. For example, the computer program instructions can be implemented as computer executable code programmed by one skilled in the art to perform an algorithm defined by the method steps of FIGS. 7 and 8. Accordingly, by executing the computer program instructions, the processor 1101 executes an algorithm defined by the method steps of FIGS. 7 and 8. Computer 1100 also includes one or more network interfaces 1104 for communicating with other devices via a network. Computer 1100 also includes one or more input/output devices 1105 that enable user interaction with computer 1100 (e.g., display, keyboard, mouse, speakers, buttons, etc.).

Processor 1101 may include both general and special purpose microprocessors, and may be the sole processor or one of multiple processors of computer 1100. Processor 1101 may include one or more central processing units (CPUs), for example. Processor 1101, data storage device 1102, and/or memory 1103 may include, be supplemented by, or incorporated in, one or more application-specific integrated circuits (ASICs) and/or one or more field programmable gate lists (FPGAs).

Data storage device 1102 and memory 1103 each include a tangible non-transitory computer readable storage medium. Data storage device 1102, and memory 1103, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1105 may include peripherals, such as a printer, scanner, display screen, etc. For example, input/output devices 1105 may include a display device such as a cathode ray tube (CRT) or liquid crystal display (LCD) monitor for displaying information to the user, a keyboard, and a pointing device such as a mouse or a trackball by which the user can provide input to computer 1100.

Any or all of the systems and apparatus discussed herein, including user device 101, messaging network 102, SMSC/MMSC 302, message routing server 303, telephone number information system 103, message handling infrastructure 104, network storage 502, messaging service APIs 503, persona based messaging infrastructure 105, persona based messaging server 602, push service network 112, push server 113, user device 107 and user device 108 may be implemented using a computer such as computer 1100.

One skilled in the art will recognize that an implementation of an actual computer or computer system may have other structures and may contain other components as well, and that FIG. 11 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of operating a persona based messaging service, the method comprising:
receiving, by a message routing server, a first message addressed to a telephone number associated with a mobile device and a business persona of a user, the mobile device associated with a second telephone number associated with a personal persona of the user separate from the business persona of the user;
determining that the telephone number is associated with the business persona of the user;
in response to determining that the telephone number is associated with the business persona of the user, storing the first message in a network storage mailbox associated with the user;
transmitting, by the message routing server, a notification to a messaging server that the first message is stored in the network storage mailbox;
retrieving, by the messaging server, the first message from the network storage mailbox; and
transmitting, by the messaging server via a wireless network, a push notification to a client located on the mobile device and associated with the telephone number.

2. The method of claim 1, further comprising:
receiving a second message addressed to the second telephone number associated with the user;
retrieving subscriber information associated with the second telephone number;
based on the subscriber information, determining that the second telephone number is device specific and associated with the mobile device; and
transmitting the second message to the mobile device via a mobile communication network.

3. The method of claim 2, further comprising:
receiving, via the wireless network, a third message sent by the client located on the mobile device, the third message addressed to a telephone number associated with a second user; and
transmitting, by a messaging server, the third message to the messaging server for delivery to a second device having the telephone number associated with the second user.

4. The method of claim 3, further comprising:
transmitting, via the messaging server, the third message to a messaging service application programming interface; and
storing, via the messaging service application programming interface, the message in network storage.

5. The method of claim 1, wherein the first message comprises a multimedia messaging service message.

6. The method of claim 2, further comprising:
receiving a request to clear all messages addressed to the telephone number associated with the user; and
transmitting the request to the client to clear all the messages addressed to the telephone number associated with the user without affecting messages addressed to the second telephone number associated with the user.

7. (canceled)

8. An apparatus for operating a persona based messaging service, the apparatus comprising:
a processor; and
a memory to store computer program instructions, the computer program instructions when executed on the processor cause the processor to perform operations comprising:
receiving a first message addressed to a telephone number associated with a mobile device and a business persona of a user, the mobile device associated with a second telephone number associated with a personal persona of the user separate from the business persona of the user;
determining that the telephone number is associated with the business persona of the user;
in response to determining that the telephone number is associated with the business persona of the user, storing the first message in a network storage mailbox associated with the user;
transmitting a notification to a messaging server that the first message is stored in the network storage mailbox;
retrieving, by the messaging server, the first message from the network storage mailbox; and
transmitting, by the messaging server via a wireless network, a push notification to a client located on the mobile device and associated with the telephone number.

9. The apparatus of claim 8, the operations further comprising:
receiving a second message addressed to the second telephone number associated with the user;
retrieving subscriber information associated with the second telephone number;
based on the subscriber information, determining that the second telephone number is device specific and associated with the mobile device; and
transmitting the second message to the mobile device via a mobile communication network.

10. The apparatus of claim 9, the operations further comprising:
receiving, via the wireless network, a third message sent by the client located on the mobile device, the third message addressed to a telephone number associated with a second user; and
transmitting, by the messaging server, the third message to a messaging server for delivery to a second device having the telephone number associated with the second user.

11. The apparatus of claim 10, the operations further comprising:
transmitting, via the messaging server, the third message to a messaging service application programming interface; and
storing, via the messaging service application programming interface, the message in network storage.

12. The apparatus of claim 8, wherein the first message comprises a multimedia messaging service message.

13. The apparatus of claim 9, the operations further comprising:
receiving a request to clear all messages addressed to the telephone number associated with the user; and
transmitting the request to the client to clear all the messages addressed to the telephone number associated with the user without affecting messages addressed to the second telephone number associated with the user.

14. (canceled)

15. A non-transitory computer readable medium storing computer program instructions for operating a persona based messaging service, which, when executed on a processor, cause the processor to perform operations comprising:
receiving, by a message routing server, a first message addressed to a telephone number associated with a mobile device and a business persona of a user, the mobile device associated with a second telephone number associated with a personal persona of the user separate from the business persona of the user;
determining that the telephone number is associated with the business persona of the user;
in response to determining that the telephone number is associated with the business persona of the user, storing the first message in a network storage mailbox associated with the user;
transmitting, by the message routing server, a notification to a messaging server that the first message is stored in the network storage mailbox;
retrieving, by the messaging server, the first message from the network storage mailbox; and
transmitting, by the messaging server via a wireless network, a push notification to a client located on the mobile device and associated with the telephone number.

16. The non-transitory computer readable medium of claim 15, the operations further comprising:
receiving a second message addressed to the second telephone number associated with the user;
retrieving subscriber information associated with the second telephone number;
based on the subscriber information, determining that the second telephone number is device specific and associated with the mobile device; and
transmitting the second message to the mobile device via a mobile communication network.

17. The non-transitory computer readable medium of claim 16, the operations further comprising:
receiving, via the wireless network, a third message sent by the client located on the mobile device, the third message addressed to a telephone number associated with a second user; and
transmitting, by a messaging server, the third message to the messaging server for delivery to a second device having the telephone number associated with the second user.

18. The non-transitory computer readable medium of claim 17, the operations further comprising:
transmitting, via the messaging server, the third message to a messaging service application programming interface; and
storing, via the messaging service application programming interface, the message in network storage.

19. The non-transitory computer readable medium of claim 15, wherein the first message comprises a multimedia messaging service message.

20. The non-transitory computer readable medium of claim 15, the operations further comprising:
receiving a request to clear all messages addressed to the telephone number associated with the user; and
transmitting the request to the client to clear all the messages addressed to the telephone number associated with the user without affecting messages addressed to the second telephone number associated with the user.
